(19) United States
(12) Patent Application Publication
(10) Pub. No.: US 2008/0259810 A1
(43) Pub. Date: Oct. 23, 2008

(54) Broadband Service Applications Test Tool

(75) Inventors: Yolius Diroo, San Antonio, TX (US); Thomas H. Adams, San Antonio, TX (US); Edward Walter, Boerne, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: AT&T KNOWLEDGE VENTURES, LP, Reno, NV (US)

(21) Appl. No.: 11/738,929

(22) Filed: Apr. 23, 2007

(51) Int. Cl. H04L 12/26

(52) U.S. Cl. 370/252

(57) ABSTRACT

A broadband internet system comprises a speed test tool, a database, and an internet portal. The speed test tool determines available bandwidth for a communication link. The database stores the available bandwidth for the communication link from the speed test tool. The internet portal offers a service to the customer based on the available bandwidth of the communication link stored in the database, therefore allowing the customer the most efficient usage of the bandwidth of the communication link.

### FIELD OF THE DISCLOSURE

The present disclosure generally relates to broadband systems, and more particularly relates to testing broadband systems.

### BACKGROUND

Providers of digital subscriber line (DSL) and cable broadband networks offer a variety of services including basic internet access, voice communications, and television. Different locations in a provider's network have different amounts of available bandwidth for supplying those services to a customer. If a communication link to the customer does not have bandwidth sufficient for a particular service, then the customer cannot use the service most effectively, it at all. Therefore, some services offered by a network provider are not feasible for all customers.

### BRIEF DESCRIPTION OF THE DRAWINGS

FIG. 1 is a block diagram of an embodiment of a broadband internet service network;

FIG. 2 is a flow chart of a method for activating a broadband internet service;

FIG. 3 is a flow chart of a method for updating a broadband internet service;

FIG. 4 is a flow chart of a method for testing a broadband internet network;

FIG. 5 is a flow chart of a method for offering a broadband internet service; and

FIG. 6 is a block diagram of a data processing device.

### DETAILED DESCRIPTION OF THE DRAWINGS

A broadband internet system includes a speed test tool, a database, and an internet portal. The speed test tool tests a communication link between a residential gateway and a digital subscriber line access multiplexer (DSLAM) to determine the bandwidth available on the communication link. The available bandwidth is stored in the database along with other information about the communication link and the customer, such as the broadband internet services supplied to the customer over the communication link. The customer is offered services through the internet portal, which the customer uses to purchase or decline the services offered. A baseline is set for the communication link after the customer purchases or declines the services offered. The baseline includes the total amount of bandwidth for the communication link, the available bandwidth for the communication link, and the services associated with the communication link. The broadband internet system continually tests and stores data about the communication link.

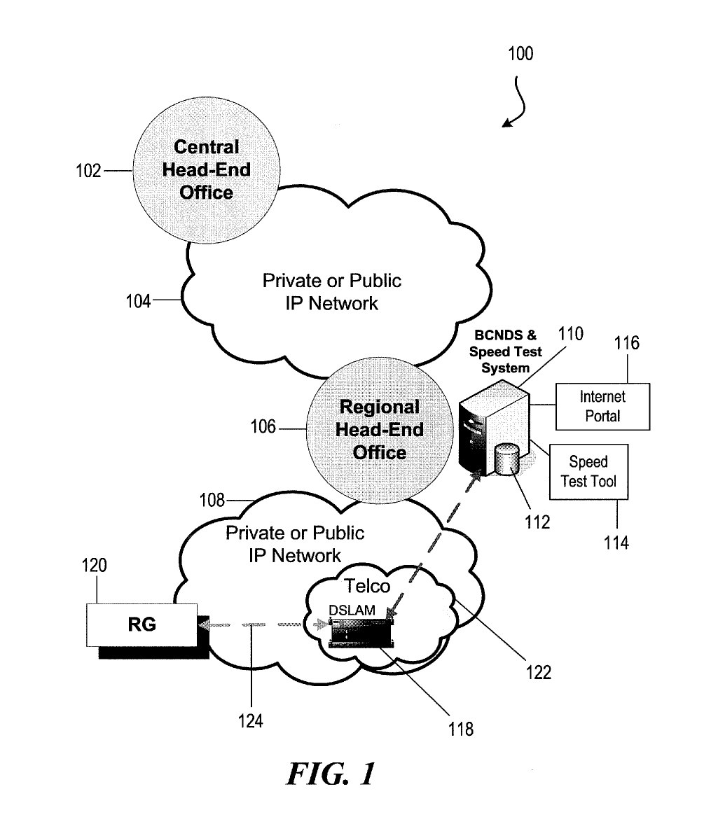

FIG. 1 shows a block diagram of a service provider network 100 including a central head-end office 102, a first private or public internet protocol (IP) network 104, a regional head-end office 106, and a second private or public IP network 108. The central head-end office 102 and the regional head-end office 106 are connected through the first private or public IP network 104. The service provider utilizes the first private or public IP network 104 and the second private or public IP network 108 to provide customers of the service provider network 100 with broadband internet services, such as internet access, telephone, and television. A bandwidth capacity and notification database system (BCNDS) and speed test system 110 is preferably located with all other regional servers (not shown) in the regional head-end office 106. The BCNDS and speed test system 110 includes a database 112, a speed test tool 114, and an internet portal or browser 116 that communicate with each other.

Within the service provider network 100, a digital subscriber line access multiplexer (DSLAM) 118 connects a customer residential gateway 120 to a telephone company network 122. The DSLAM 118 provides the customer access to the different services offered by the telephone company network 122 over a communication link 124. In different embodiments, the communication link is a single communication link, multiple communication links, or a hybrid communication link. The communication link 124 may include twisted copper pairs, optical fiber, coaxial cable or wireless conductivity.

The speed test tool 114 performs a plurality of different tests in real-time on the communication link 124 including identifying its total bandwidth capacity, the bandwidth currently used by each service supplied to the customer over the communication link 124, and the bandwidth available over the communication link 124. The BCNDS and speed test system 110 automatically sends alerts to the telephone company network 122 when the communication link 124 is under adverse conditions, such as when the services supplied to the customer approach or exceed the available bandwidth of the communication link. All of the information obtained during these tests is recorded in the database 112 of the BCNDS and speed test system 110 for periodic reporting.

The speed test tool 114 or another application in the system also compares the available bandwidth over the communication link 124 to a network quality of service (QoS) policy that specifies the bandwidth required for any of a plurality of services offered to the customer. The speed test tool 114 is accessible, by the customer, through the internet portal 116. The customer is therefore able to run the speed test tool 114 and determine if sufficient bandwidth is available on the communications link 124 for a particular service in which the customer is interested. If the bandwidth available over the communication link 124 does not meet the minimum QoS requirements for the service offered, then the system indicates that the service is not available to the customer.

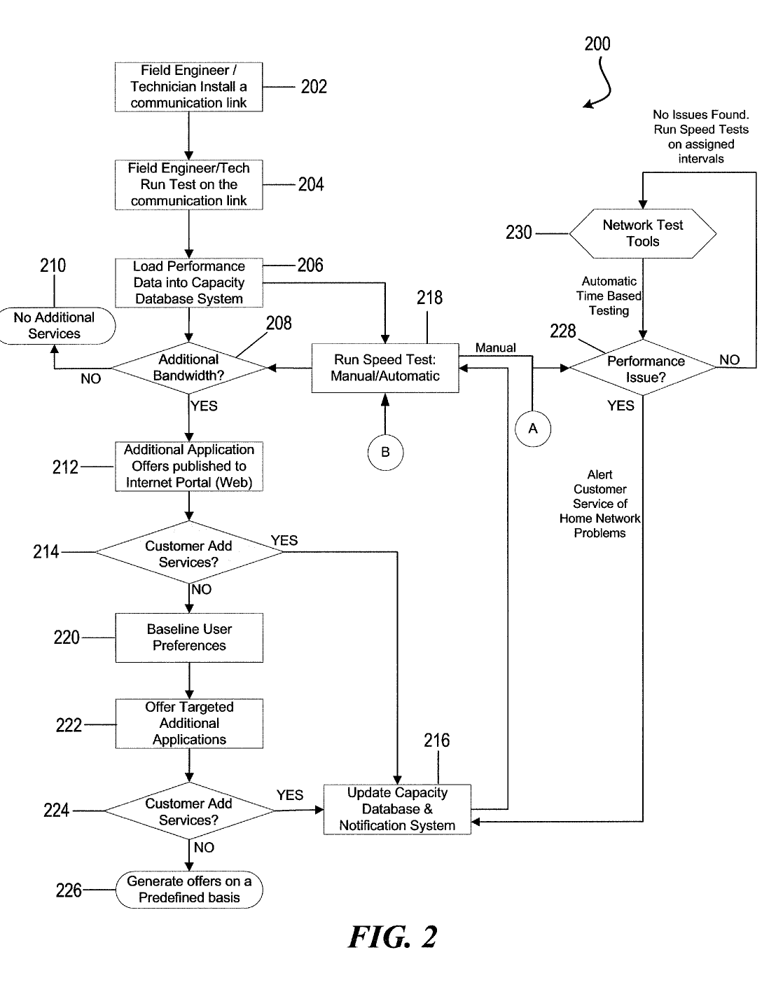

FIG. 2 shows a flow chart of a method 200 for activating a broadband internet service. At block 202, a field engineer/technician installs a communication link for a customer. At block 204, the installer tests the communication link to obtain an initial bandwidth performance reading. The communication link information, along with load capacity performance, is stored in a database in a bandwidth capacity and notification database system (BCNDS) at block 206. At block 208, the information in the database of the BCNDS is used to determine whether the communication link has any additional bandwidth after accounting for services initiated at installation. At block 210, if the communication link does not have any additional bandwidth, then no additional services are offered to the customer. However, if additional bandwidth is available, one or more services are offered to the customer through an internet portal, and a sales representative is alerted of potential additional services available for the communication link at block 212. At block 214, the customer has the opportunity to select or decline the additional service or services. At block 216, if the customer elects to purchase a service, then the service is added to the communication link and the database of the BCNDS is updated. A speed test tool automatically runs to validate that the communication link has enough bandwidth for the service selected by the customer at block 218. If the customer elects not to purchase any additional services, a baseline for the communication link is created at block 220. The baseline includes the total bandwidth for the communication link, the available bandwidth for the communication link, and one or more services subscribed to by the customer. The baseline for the customer is used to determine specific services to offer the customer via the internet portal at block 222. At block 224, the customer once again has the option to decide whether or not to purchase additional services. At block 216, if the customer elects to purchase a service, then the service is added to the communication link and the database of the BCNDS is updated. At block 226, if the customer elects not to purchase the services, new service offers are made at predefined intervals.

At block 228, the speed test tool determines whether there is a performance issue for the communication link. At block 230, network test tools, such as the speed test tool, continue to perform tests on a predefined timeframe when no performance issues are detected. The database of the BCNDS is updated with the current information for the communication link when a performance issue is found, and the help desk is sent notification of the issue at block 224.

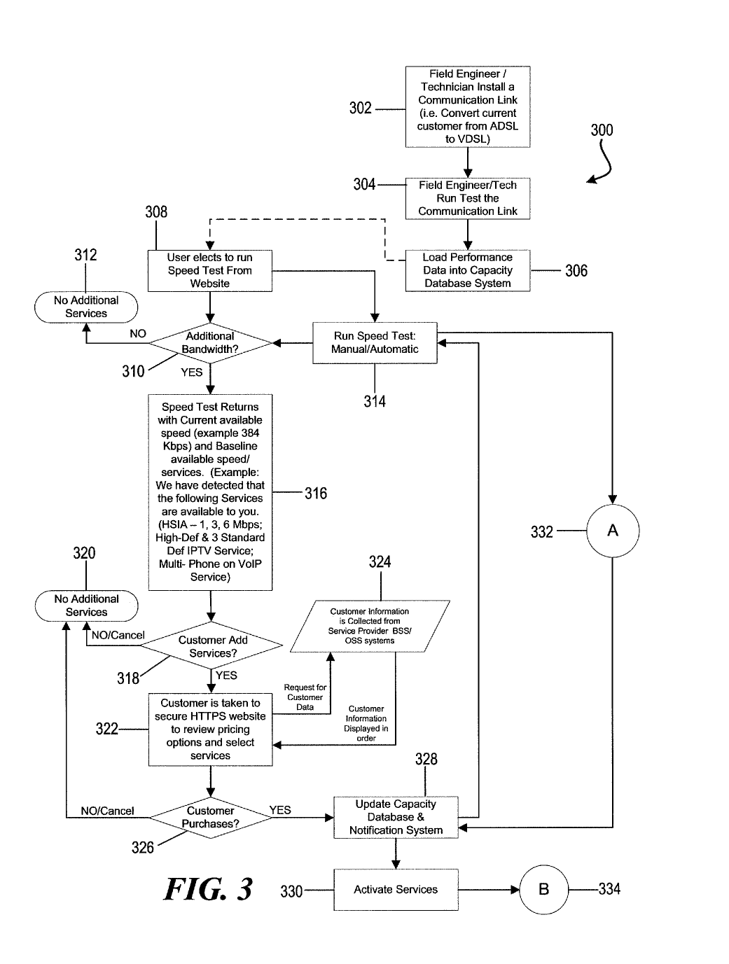

FIG. 3 shows a flow chart of a method 300 for updating a broadband internet service. In this exemplary method, the customer has installed a next generation digital subscriber line (DSL) modem which is capable of auto-detecting DSL types. An engineer/technician installs a communication link for a customer in block 302. At block 304, the engineer/technician runs a test to establish a baseline for the communication link to the customer. The baseline data is loaded into a database of a bandwidth capacity and notification database system (BCNDS) at block 306.

At block 308, the customer elects to run a web-enabled speed test tool from an internet portal. The customer is identified as a non-Internet Protocol Television customer, and therefore a standard bandwidth measurement of the total available bandwidth of a communication link is performed at block 310. If the communication link for the customer has no additional bandwidth, no additional services are offered to the customer at block 312. The speed test tool performs the test to determine the available bandwidth at block 314. Available services for the customer are selected based on the available bandwidth of the communication link, and a service is offered to the customer at block 316. The customer is prompted to add the available services at block 318. If the customer elects not to purchase the service, the service is not added over the communication link at block 320. At block 322 if the customer elects to purchase the service, the customer is forwarded to a secure website to review pricing options. The customer selects the service in a “Shopping Cart” fashion, and customer information is pulled from existing billing systems at block 324. If the customer cancels the purchase, no service is added to the communication link at block 320. Once the customer finalizes the purchase the database of the BCDNS is updated with the new service at block 328. At block 330, the service purchased by the customer is activated. The speed test tool tests the communication link to check for performance issues at block 332. The network tools, such as the speed test tool, conduct test on the communication link at predetermined time intervals as shown by the loop of blocks 228 and 230 in FIG. 2. Additionally, the speed test tool tests of the available bandwidth for the communication link at block 334, wherein the speed test tool runs at block 218 of FIG. 2.

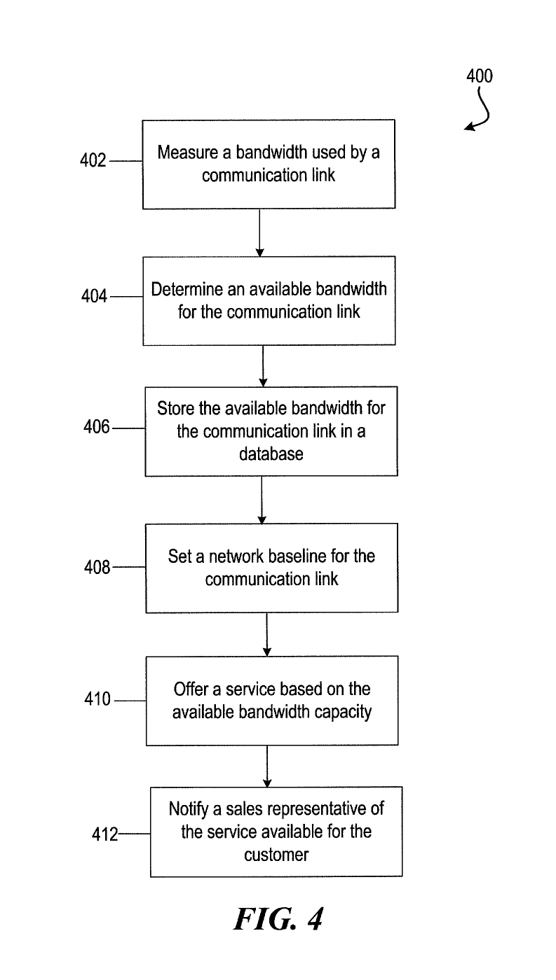

FIG. 4 is a flow chart of a method 400 for testing a broadband internet network. At block 402, a speed test tool measures the bandwidth used by a communication link. The speed test tool determines the available bandwidth for the communication link upon installation of one or more services to the communication link at block 404. At predetermined time intervals following the initial determination of available bandwidth for the communication link, the speed test tool again determines the available bandwidth. At block 406, the available bandwidth for the communication link is stored in a database. A baseline is set for the communication link at block 408. The baseline includes the total bandwidth for the communication link, the available bandwidth for the communication link, and the one or more services subscribed to by a customer of the communication link. At block 410, a service is offered to the customer based on the available bandwidth for the communication link. A sales representative is notified of the available service for the customer at block 412.

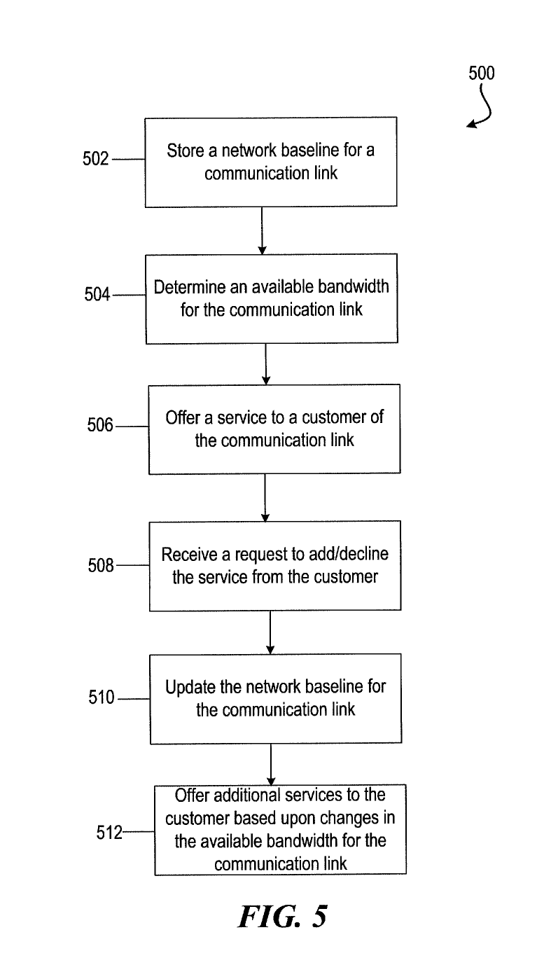

FIG. 5 is a flow chart of a method 500 for offering a broadband internet service. At block 502, a baseline for a communication link for a customer is stored in a database. The baseline includes the total bandwidth for the communication link, the available bandwidth for the communication link, and the one or more services subscribed to by the customer of the communication link. A speed test tool determines the available bandwidth of the communication link at block 504. At block 506, the customer is offered a service based on the available bandwidth for the communication link. An internet portal receives a request from the customer to add or decline the services at block 508. The baseline is updated to reflect the service added to the communication link or any changes in the available bandwidth of the communication link at block 510. Additional services are offered to the customer at predetermined time intervals based on changes in the available bandwidth of the communication link at block 512.

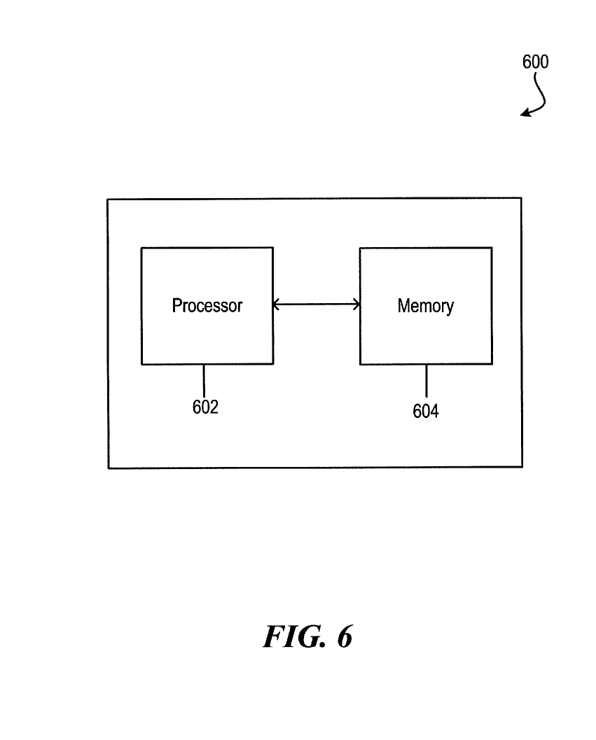

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein. FIG. 6 is a block diagram of a data processing device 400 comprising a processor 602 and a computer-readable device such as a memory 604. The memory 404 stores a set of instructions to manipulate the processor to perform the methods 200, 300, 400, and 500 of FIGS. 2, 3, 4 and 5 above. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Although the present specification describes components and functions that may be implemented in particular embodiments with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIG.s are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A broadband internet system comprising:
a speed test tool operably configured to determine an available bandwidth of a communication link;
a database in communication with the speed test tool, the database operably configured to store the available bandwidth of the communication link determined by the speed test tool; and
an internet portal in communication with the database, the internet portal operably configured to offer a service to a customer based on the available bandwidth of the communication link stored in the database.

2. The broadband internet system of claim 1 wherein the speed test tool determines the available bandwidth for the communication link at predefined intervals.

3. The broadband internet system of claim 2 wherein the internet portal additionally receives a response from the customer to purchase the services offered.

4. The broadband internet system of claim 3 wherein the database additionally stores a baseline for the communication link.

5. The broadband internet system of claim 4 wherein a baseline includes a total bandwidth for the communication link, the available bandwidth for the communication link, and one or more services subscribed to by the customer.

6. The broadband internet system of claim 5 wherein the services purchased is added to the baseline of the communication link.

7. The broadband internet system of claim 1 wherein the communication link is between a residential gateway and a telephone company.

8. A method of testing a communication link in a broadband internet system, the method comprising:
determining an available bandwidth for the communication link;
storing the available bandwidth for the communication link in a database; and
offering a service to a customer based on the available bandwidth for the communication link.

9. The method of claim 8 wherein the available bandwidth is determined upon installation of one or more services to the customer.

10. The method of claim 8 wherein an internet portal offers the service to the customer.

11. The method of claim 10 wherein changes in the available bandwidth for the communication link are updated and stored in the database.

12. The method of claim 8 wherein a speed test tool determines the available bandwidth for the communication link at predefined intervals.

13. The method of claim 8 wherein a baseline for the communication link includes a total bandwidth for the customer, the available bandwidth for the customer, and one or more services subscribed to by the customer.

14. The method of claim 8 further comprising:
notifying a sales representative of an available service for the customer.

15. A computer readable medium comprising a plurality of instructions to manipulate a processor, the plurality of instructions comprising:
instructions to determine an available bandwidth for a communication link;
instructions to store the available bandwidth for the communication link in a database; and
instructions to offer a service to a customer based on the available bandwidth for the communication link.

16. The computer readable medium of claim 15 wherein a baseline includes a total bandwidth for the communication link, the available bandwidth for the communication link, and one or more services subscribed to by the customer.

17. The computer readable medium of claim 16 wherein the service offered is within the available bandwidth for the communication link.

18. The computer readable medium of claim 17 wherein the baseline for the communication link is stored in a database.

19. The computer readable medium of claim 15 wherein the customer is offered the service through an internet portal.

20. The computer readable medium of claim 15 wherein the available bandwidth is determined upon installation of one or more services to the customer.
